(19) United States
(12) Patent Application Publication
(10) Pub. No.: US 2022/0222732 A1
(43) Pub. Date: Jul. 14, 2022

(54) Themed Smart Basket For Online Shopping

(71) Applicant: Mercatus Technologies Inc., Toronto (CA)

(72) Inventors: Tony SHUPARSKY, Toronto (CA); Sean O'HAGAN, Brantford (CA)

(73) Assignee: Mercatus Technologies Inc., Toronto, ON (CA)

(21) Appl. No.: 17/606,923

(22) PCT Filed: May 11, 2020
(86) PCT No.: PCT/CA2020/050639

§ 371 Date: Oct. 27, 2021

Related U.S. Application Data
(60) Provisional application No. 62/845,679, filed on May 9, 2019.

(51) Int. Cl. G06Q 30/06

(52) U.S. Cl. CPC G06Q 30/0631; G06Q 30/0633

(57) ABSTRACT

In embodiments of the present invention, a method of electronic commerce is provided that includes: maintaining a plurality of items to be purchased; maintaining a plurality of item identifiers corresponding to the plurality of items; receiving input from a shopper, the input comprising an item identifier associated with at least one of the plurality of items to be purchased by the shopper; maintaining purchase history for the shopper based on the input; and offering to the shopper, new items to be purchased, based on the purchase history.

### TECHNICAL FIELD

The present disclosure relates generally to online commerce and more particularly to shopping systems that offer tailored and relevant user experiences for shoppers.

### BACKGROUND

Electronic commerce where consumers order items online and provide an address for delivery, and where retailer fulfils the order by preparing and delivering the requested items to the provided delivery address are known.

Electronic commerce has proven very popular in communities that have reliable data network connectivity for both ordering online and processing payments, as well as the necessary physical infrastructure for transportation that enable delivery of purchased goods within predictable periods.

One-time online purchases of reasonably sized physical goods, where there are no meaningful differences between items of the same specification, are now common. In addition, many consumers have proven willing to order items and services online that entail periodic payments. The enormous growth of electronic commerce is a testament to the increasing willingness of consumers to engage in online shopping of standard items such as books and electronic items.

In addition to the purchase of goods, online shopping has also become very popular as a platform for signing up for new services such as getting cable television or wireless telephone service.

However, the user experience offered by online shopping platforms leads to various undesirable effects. The standardization of online offerings typically does not take the unique needs of the shopper into account and generally imposes one-size-fits-all approach to customer interaction.

Moreover, with the explosive growth of choice of goods and services offered by online retailers and vendors, consumers often find it difficult and time-consuming, to wade through the enormous list of available items and service offerings to find what they need, when they need it.

Accordingly, improved shopping systems that mitigate at least some of the aforementioned problems are desired.

### SUMMARY

In accordance with one aspect of the present disclosure, there is provided In embodiments of the present invention, a method of electronic commerce is provided that includes: maintaining a plurality of items to be purchased; maintaining a plurality of item identifiers corresponding to the plurality of items; receiving input from a shopper, the input comprising an item identifier associated with at least one of the plurality of items to be purchased by the shopper; maintaining purchase history for the shopper based on the input; and offering to the shopper, new items to be purchased, based on the purchase history.

This summary does not necessarily describe the entire scope of all aspects of the disclosure. Other aspects, features and advantages will be apparent to those of ordinary skill in the art upon review of the following description of specific embodiments.

### BRIEF DESCRIPTION OF DRAWINGS

In the accompanying figures, which illustrate by way of example only, one or more embodiments of the present invention:

FIG. 1 is a schematic system block diagram of a system for utilizing a client device running an application, a server, and a store having a number of items for purchase, in a one embodiment of the present invention;

FIG. 2 is a simplified block diagram of hardware components of the exemplary server computing device used in FIG. 1;

FIG. 3 is a simplified block diagram of hardware components of one of the mobile client devices depicted in FIG. 1;

FIG. 4 is a schematic illustration of an example of a graphical user interface of the application run by the shopper using one of the client devices of FIG. 1;

FIG. 5 is a schematic illustration of an example of another graphical user interface of the application run by the shopper using one of the client devices of FIG. 1;

FIG. 6 is a schematic illustration of an example of another graphical user interface of the application run by the shopper using one of the client devices of FIG. 1 depicting quick-add digital baskets; and

FIG. 7 is a basic flowchart of exemplary steps undertaken by the store server of FIG. 1 to provide product recommendations to a shopper.

FIG. 8 is a flowchart diagram of exemplary steps undertaken by the store server of FIG. 1 to provide a themed shopping experience to a shopper.

### DETAILED DESCRIPTION

As noted above, conventional systems for ordering items online from retailers are known. A consumer that wants to place an order uses a client side system of hardware and software, such as a personal computer running a web browser, a mobile device with a compatible app, or another web-enabled software and hardware, to send the request for information describing the item to be ordered. The server system sends information to the client system along with an indication of actions to perform on a user interface to place the order for the item. When the consumer performs the required actions, the client system sends related instructions to the server system which completes the order. In embodiments of the present invention, systems that allow customized or tailored user experiences, that take into account one or more factors such as brand sensitivity, price sensitivity, replenishment rate for certain classes of items, seasonality and other methods of filtering and customizing the items offered.

In this disclosure, the terms “comprising”, “having”, “including”, and “containing”, and grammatical variations thereof, are inclusive or open-ended and do not exclude additional, unrecited elements and/or method steps. The term “consisting essentially of” when used herein in connection with a composition, use or method, denotes that additional elements, method steps or both additional elements and method steps may be present, but that these additions do not materially affect the manner in which the recited composition, method, or use functions. The term “consisting of” when used herein in connection with a composition, use, or method, excludes the presence of additional elements and/or method steps.

Directional terms such as “top”, “bottom,” “upwards,” “downwards,” “vertically,” and “laterally” are used in the following description for the purpose of providing relative reference only, and are not intended to suggest any limitations on how any article is to be positioned during use, or to be mounted in an assembly or relative to an environment. The use of the word “a” or “an” when used herein in conjunction with the term “comprising” may mean “one,” but it is also consistent with the meaning of “one or more,” “at least one” and “one or more than one.” Any element expressed in the singular form also encompasses its plural form. Any element expressed in the plural form also encompasses its singular form. The term “plurality” as used herein means more than one, for example, two or more, three or more, four or more, and the like.

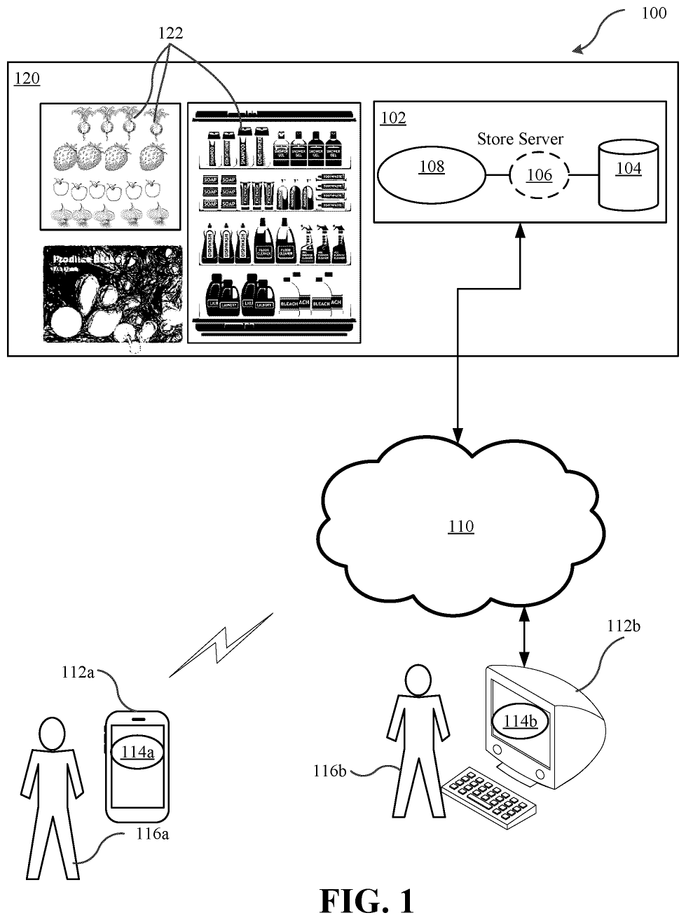

A system that offers the consumer to shop for items in a manner that is custom tailored to the needs and preferences of the consumer, exemplary of an embodiment of the present invention includes a server and a client device as illustrated in FIG. 1.

FIG. 1, depicts a simplified block diagram of a system 100 that includes a store 120 containing multiple items 122 for sale which may include items for purchase such as grocery and household items available for purchase online.

A store server 102 in data communication with one or more digital electronic or computing devices 112a, 112b (individually and collectively, devices 112) used respectively by shoppers 116a, 116b (individually and collectively, shoppers 116), via a network 110 hosts an online e-commerce platform for the store 120.

The server 102 includes a database 104, an app server or a web-server software 108, and a business application logic 106 and adapted for facilitating communication between the database 104 and the web-server software 108. Web-server software 108 is adapted for communicating with client side applications 114a, 114b (individually and collectively, application 114 or “app 114”) running on a devices 112a, 112b respectively. The web-server software 108 can be any suitable web-server software that is adapted to permit applications, apps, client applications or browser software, running on devices 112, to access data on server 102 through network 110. Suitable web-server software includes, but is not limited to, the Apache HTTP Server, the Internet Information Server (IIS). In other embodiments, the server side computing system can be a system comprising a network of computers (e.g. database server computer, application logic server computer, web-server computer), or a cloud service that uses a large network of server computers (e.g. database server computers, application logic server computers, web-server computers), the server computers collectively hosting multiple instances of application logic server software, database software, and web-server software. In other embodiments, the system does not include a web-server software running on a server that communicates to an app running on devices 112.

Each of the computing devices 112 access the store server 102 through an application 114 running thereon, such as a browser (e.g., Chrome™, Internet Explorer™, Mozilla Firefox™, Safari™) or a mobile browser software, via the Hypertext Transfer Protocol (HTTP) or its secure version (HTTPS) for data entry, shopping item selection, payment data entry, delivery address data entry, shipping address data entry, and various other activities enabled by the electronic commerce platform as will be described later. In other embodiments, the server is not accessed via HTTP or HTTPS, but instead is accessed via another suitable protocol.

Application logic 106 executing on server 102 implements application logic rules for system 100. As contemplated in this first embodiment, application logic 106 can be implemented as software components, services, server software, or other software components forming part of application logic 106. Application logic 106 encodes specific business rules determining the creation, manipulation, alteration, generation, or verification of data using data received from devices 112 or retrieved from database 104.

Database 104 provides storage for persistent data. Persistent data includes, but is not limited to, data related to items for sale in a store, such as name, prices, promotion periods, discounts, eligibility criteria, coupon information and the like. As is known in the art, persistent data is often required for applications that reuse saved data across multiple sessions or invocations. As contemplated in this first embodiment, database 104 is supported by a relational database management software (RDBMS), and is encrypted.

Suitable RDBMS include, but are not limited to, the Oracle® server, the Microsoft SQL Server database, the DB2 server, MySQL server, and any alternative type of database such as an object-oriented database server software. Encryption can be done by any method known in the art. Suitable encryption methods or algorithms include, but are not limited to, RSA public-key encryption, Advanced Encryption Standard (AES), Triple Data Encryption Algorithm (3DES), and Blowfish. In other embodiments, the database on the server side computing system is not an RDBMS. In other embodiments, the database is not encrypted.

In alternate embodiments, server 102 has a separate database server hardware to host database 104. In other embodiments, the system has a separate application server computer for the purpose of providing additional resources in terms of processors, memory capacity, and storage capacity in order to improve the performance of the system. In other embodiments, the system further comprises a business logic server that is external to server 102, the business logic server for hosting an application logic (e.g. application logic 106). Other computing devices suitable for communication with server 102 or as devices 112 include, but are not limited to, server class computers, workstations, personal computers, and any other suitable computing device.

In this first embodiment, network 110 is the Internet. In other embodiments, the network can be any other suitable network including, but not limited to, a cellular data network, Wi-Fi™, Bluetooth™, WiMax™, IEEE 802.16 (WirelessMAN), and any suitable alternative thereof. The suitable data communications interface contemplated in this embodiment between devices 112 and network 110 is wireless. The interface can be an antenna, a Bluetooth™ transceiver, a Wi-Fi™ adapter, or a combination thereof.

As contemplated in this first embodiment, device 112a may be smartphone, a tablet device, or another handheld electronic device. Non-limiting examples of such handheld devices include smartphones (e.g. iPhone™, Blackberry™, Windows™ Phone, Android™ phone), personal digital assistants (PDAs), cellular telephones, media players (e.g. iPod™), and a device which combines one or more aspects or functions of the foregoing devices.

On the other hand, device 112b may be a desktop or laptop computer, such as a personal computer (PC) or laptop running Windows® or Linux, MacBook®, MacBook Pro®, MacBook Air®, iMac®, Mac® Mini, or Mac Pro® from Apple Inc. In other embodiments, the devices can be any other suitable electronic devices having a suitable data communications interface to network 110. One or more of devices 112 are used by the consumers to participate in electronic commerce.

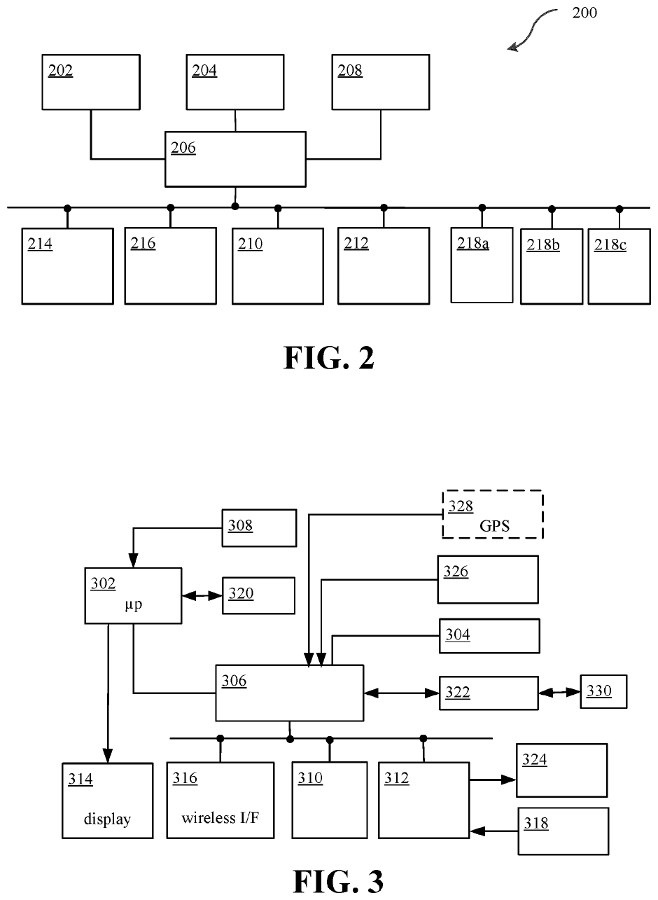

FIG. 2, depicts a simplified block diagram of computing device hardware 200. Hardware 200 comprises a processor 202 such as, but not limited to, a microprocessor, central processing unit (CPU), a digital signal processor (DSP) or the like; a memory medium 204, and interface circuit 206 adapted to provide a means of communication between processor 202 and memory medium 204.

Interface circuit 206 also interconnects input and output (I/O) components such a display 214, a network adapter 216, and a storage medium 210. Interface circuit 206 also interconnects a printer 212 and one or more additional peripherals 218a to 218c (individually and collectively, peripherals 218). Suitable peripherals 218 include, but are not limited to a keyboard, a camera, a scanner, a touch panel, a joystick, an electronic mouse, touch screen, track-pad, and other input or pointing devices, and any combination thereof. In other embodiments, the interface circuit does not interconnect a printer. In other embodiments, the interface circuit does not interconnect any peripherals.

Memory medium 204 may be in the form of volatile memory or a combination of volatile and non-volatile memory, including, but not limited to, dynamic or static random access memory (RAM), read-only memory (ROM), flash memory, solid state memory and the like.

Interface circuit 206 includes a system bus for coupling any of the various computer components 210, 212, 214, 216, 218 to the processor 202. Suitable interface circuits include, but are not limited to, Industry Standard Architecture (ISA), Micro Channel Architecture (MCA), Extended Industry Standard Architecture (EISA), VESA Local Bus (VLB), Peripheral Component Interconnect (PCI), Peripheral Component Interconnect Extended (PCI-X), Accelerated Graphics Port (AGP), Peripheral Component Interconnect Express (PCIe).

Storage medium 210 can be any suitable storage medium including, but not limited to, a hard disk drive (HDD), a solid state drive (SSD), EEPROM, CD-ROM, DVD, and any other suitable data storage element or medium. Storage medium 210 is readable by processor 202.

Display 214 can be any suitable display including, but not limited to, monitor, a television set or a touch screen.

Network adapter 216 in server 102 facilitates wired or wireless connections to an Ethernet, Wi-Fi™, Bluetooth™, cellular network or other suitable network, thereby enabling connection to shared or remote drives, one or more networked computer resources, other networked devices, I/O peripherals and the like. Devices 112 also contain complementary network adapters therein for connecting with a suitable network, and are further equipped with browser or other thin-client or rich-client software. As contemplated in this embodiment, network adapter 216 comprises a wireless network interface card that allows communication with other computers through a data network such as network 110. In other embodiments, the network adapter does not comprise a wireless network interface card. In other embodiments, the network adapter communicates with the network via a wired connection.

In some embodiments, the hardware architectures of computing device 112b and server 102 may be as depicted in FIG. 2.

FIG. 3, depicts a simplified block diagram of exemplary embodiment of a client device hardware such as mobile device 112a. Device 112a comprises a processor 302 such as, but not limited to, a microprocessor, a memory 304, a touch input 308, a battery 320, and a display 314. Several components and processor 302 communicate with each other through an interface circuit 306. Interface circuit 306 also interconnects components including, but not limited to, a wireless network interface 316, a storage medium 310, an input-output (I/O) interface 322, a camera 326, an audio codec 312 and a positioning module 328 such as a GPS unit. Audio codec 312 in turn connects to one of more microphones 318 and one or more speakers 324. A sensor 330 and/or other components may interconnect to processor 302 via I/O interface 322.

Wireless network interface 316 includes one or more of a wireless LAN transceiver (e.g. Wi-Fi™ transceiver), an infrared transceiver, a Bluetooth™ transceiver, and a cellular telephony transceiver. I/O interface 322 may include one or more wired power and communication interfaces such as a USB port.

Input 308 may be a keypad or keyboard, a touch panel, a multi-touch panel, a touch display or multi touch display having a software keyboard or keypad displayed thereon.

Application software or processor executable instructions executing on the client device 112 are used to interact with software on server 102. Exemplary software components, user interfaces, use cases and interactions provided below.

In operation, a customer will be presented with user interface that allows him or her to have customized interface, and shopping interactions as well as filtering of data via software application 114 running on device 112.

In accordance with one embodiment of the present invention, there is a feature that will be referred to herein as “My Store™”.

My Store™ contains a historical list of all unique products that an associated shopper 116 has ever purchased. My Store™ thus enables features that depend on the historical purchase or browsing data that may reveal inferred preferences such as brand affinity for a plurality of brands, price sensitivity, computed replenishment rates of some items, and current needs based on such computed rates and the like.

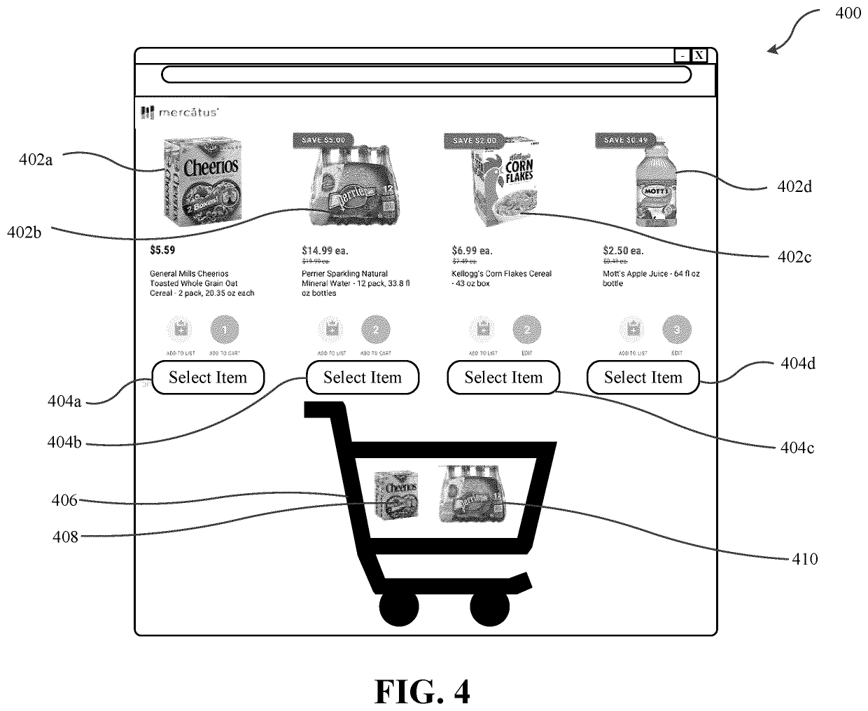

Initially My Store™ may not have any historical data and may simply present a page similar to page 400 shown in FIG. 4. As shown store items 402a, 402b, 402c 402d (individually and collectively items 402) may be displayed and available for selection using buttons 404a, 404b, 404c 404d (individually and collectively buttons 404). User interactions with page 400 are used to build up a historical record for My Store™.

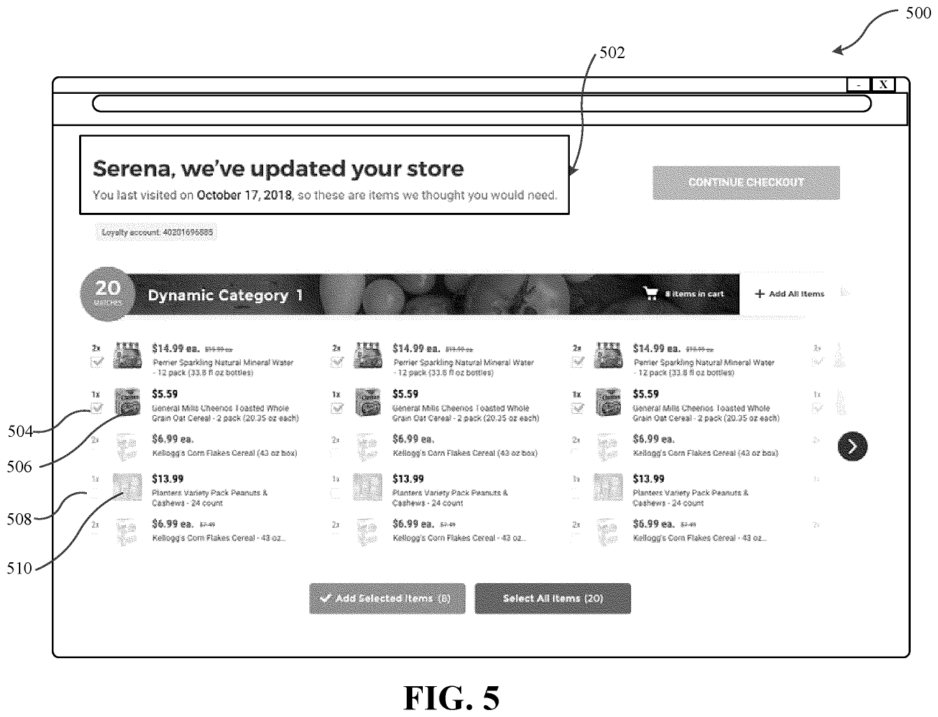

As purchases are made data associated with My Store™ is updated as shown in an exemplary updated page 500 in FIG. 5. The updated page 500 is only exemplary and as will be understood by persons of skill in the art and many alternatives are possible. A text box 502 may be used to indicate that the current customer's My Store™ has been updated and the date of last visit may be indicated as shown.

A checkbox element 504 may be ticked by a shopper to indicate a selected corresponding item 506. An unchecked element 508 indicates the corresponding item 510 has not been selected for possible addition to the shopping cart.

The displayed items may be selected and displayed in accordance with a number of factors computed by the exemplary system. These factors include one or more of brand sensitivity, price sensitivity, replenishment rates, seasonal items, supplier relationships, profit margins, marketing campaigns and the like as will be detailed below.

Brand sensitivity level is used to determine whether to show branded items in some categories of products, or whether more generic items should be shown by an exemplary shopping platform for a particular user, customer or shopper (e.g., shopper 116). If the present shopper exhibits sensitivity to a selected set of brands as determined by analysis of the data contained in his or her historical list, then the associated “My Store™” shows branded items of relevance. In one exemplary embodiment, this may be determined by the relative frequency of a branded item that is purchased, relative to the total number of items purchased in that category. The historical list in My Store™ is used to determine brand sensitivity.

An example may be illustrated by toothpaste. A threshold may be set to the relative frequency of purchases to determine brand sensitivity so that if the relative frequency of items of a particular brand is at or above the threshold then the shopper is deemed to show brand sensitivity to the brand. As a specific example, if the shopper purchased 100 tubes of toothpaste as recorded in “My Store™” of which say 85 are Colgate™, then shopper is deemed to show brand sensitivity to Colgate™ since 85/100>50%=threshold. In this case, no other brands will be shown to the shopper during shopping. Conversely, if the brand sensitivity level is below threshold, then other brands or store branded items or even no-brand generic items may be shown to the shopper. The retailer may of course prioritize this alternate list by profitability, relationships with suppliers, or other strategic or risk management considerations. In this disclosure, brand affinity is the same concept as brand sensitivity. Stronger brand affinity implies that a shopper is unlikely to consider an alternative or equivalent product even at a significantly lower price. The larger the price gap that would cause a switch, the stronger brand affinity.

Price sensitivity is used to determine the relative effect that prices will have on the shopping behavior of a subject shopper. For example, given two shoppers that buy the same item, if an increase in price of a certain percentage causes the first shopper to switch to a cheaper alternative while the second shopper continues to buy the same item, then the first shopper is said to be more price sensitive than the second shopper, with respect to the item in question.

In embodiments of the present invention, price sensitivity along with price sensitivity may be used to determine whether the online shopping platform shows cheaper alternatives to the shopper, during the shopper's online session. For example, sale items may be prominently displayed for price sensitive shopper.

Among the characteristics or metrics that can be computed for the shopper based on his or her shopping history are replenishment rates associated with certain items. For example, analysis of the historical list in My Store™ may indicate that the shopper buys a certain number of toothpastes or paper towels, about every six weeks. Embodiments of the system are thus able compute the replenishment rate for a given item and determine whether or not to offer or display certain items that are or may be close to being completely consumed and in thus need of replenishment. Of course, replenishment rates are independent of price sensitivity or brand sensitivity.

Items shown to shoppers may thus be based on one or more of brand sensitivity and price sensitivity. For example, depending on price sensitivity and brand sensitivity, a shopper may be shown a cheaper product that may be on sale, that shopper has not previously purchased.

In operation, My Store™ may display seasonal items prominently such as at the top of a display, during the appropriate season. For example items associated with a holiday season such as Christmas cards, holiday cards or other Seasons Greetings type cards may be offered for sale and prominently displayed during the holiday season.

While the dataset in general may involve thousands of product items or more, with in My Store™, there are often a few hundred items that the shopper has bought and is likely to buy. This permits serving up a dataset in real time to the shopper while he or she is online using a server, and a client side browser or app. If an exemplary server platform such as the Mercatus e-commerce platform is not employed, in some embodiments the server may deliver the relevant dataset in batch mode to the client. Undertaking search operations within the My Store™ digital environment allows fast searches to be performed as the data set involved typically numbers a few hundred (e.g., about 300) rather than the typical number of product items which may number in the tens of thousands (e.g., about 40,000).

The client side software application 114 such as a browser on the desktop, an app on a mobile device, touch screen kiosk, or another thin-client or fat-client software running on suitable hardware, may be used by the shopper in at least two modes of search.

In one embodiment, the first mode of search may be a filtered search that is performed on the list of historical purchases of the shopper, available with My Store™. Faster search results may be expected with this first mode of search as the list to be searched would be a subset of all available items.

The second mode of search is a regular search performed on all available items at the retailer. This mode of search may take longer than the first mode of search as the search list is a superset of the filtered list used in the first mode.

In this embodiment, a switch between the first mode of filtered search and the second mode of regular search may be effected with a simple click of a button or a single touch or other similarly quick and simple action on a user interface available to the client side software. My Store™ may further be augmented with personalized offers, coupons and other novel items that are tailored to the shopper. The personalization may be determined based on the purchase history of the client and other data that may be considered together with the purchase history such as demographic profile, geographic location, season, employer profile, etc.

All of the recommendations are made based on historical purchases of by the shopper using the application 114 as well as all other shoppers. Server 102 may also use shopper preferences or aspirations such as stated weight loss goals to highlight products the shopper has not purchased in the past, but might be interested in based on said aspirations. As well, external factors such as, weather, season, demographics, etc. may be used to recommend products.

When comparing a shoppers' pattern versus those of people like them (via segmentation and tagging), server 102 can discover gaps. These gaps are products that the shopper is likely purchasing elsewhere but not purchasing at the current retailer. The server 102 may thus may suggest such products, especially if the products are on sale.

In some embodiments of the present invention, a tool that will be referred to herein as “Basket Builder” may be provided on the client software. The Basket Builder is a filtered version of My Store™ that includes what the shopper is likely to want at present.

Replenishment items may be offered based on the replenishment cycle for some items that are known to be purchased at regular intervals weighted for the number of items that are already been purchased. For example, a set of items such as paper towels may be determined to be consumed at a rate of about one per week. Accordingly if the shopper is known to have purchased eight (8) paper towels eight weeks ago, then the Basket Builder may automatically place some paper towels for purchase.

Other ways of replenishment rates may be empirically determined, for example, by simply averaging the number of items purchased over a certain period of time of sufficient length to provide for statistically significant values. More sophisticated modelling may also be attempted based on the demographic profile of the family associated with the particular instance of My Store™.

Other deterministic analytical methods or empirical statistical approaches may be used in algorithms employed as will be discussed later.

The search for placing items using Basket Builder is similar to the search procedure described above with reference to My Store™. Moreover, personalized offers, coupons and other novel items may be offered.

Accordingly, a smaller data set is involved with often a few hundred items which permits serving up a dataset in real time. Batch mode delivery of data from the server to the client is possible. As will be expected, a faster search than the unfiltered search will result and this may be expanded to include all items as desired.

If the algorithm to generate the smart basket ends up with weak results, then the search algorithm can default to My Store™. Alternately, the shopper can change contexts and attempt to get better search results. Weakness implies that server 102 does not have enough historical data on a specific shopper to build a complete set of recommendations. When this happens, server 102 will fall back to products popular within the segment associated with the current shopper.

In one computer implemented exemplary embodiment, the client side user interface may provide the shopper with discovery block that act as gateways to additional products or services available on server 102 that should be of interest to the shopper and will potentially result in additional items being added to the cart before checkout.

Examples of discovery blocks include predefined digital baskets, referred to herein as quick-add baskets. When the shopper clicks one of the quick-add baskets, the items in the selected items may be added to the shopping basket.

Quick-add baskets may be displayed on application 114 at the end of the utility portion of a quick cart builder process. In some embodiments, the utility portion of the quick cart builder helps a shopper complete his or her weekly basket as quickly and easily as possible. Once these weekly items have been selected, server 102 guides the shopper into a more exploratory mode via application 114 discover items that available at the retailer that shopper may be unfamiliar with. The number and types of these discovery blocks presented will be specific to a shopper based on their behavior and segments.

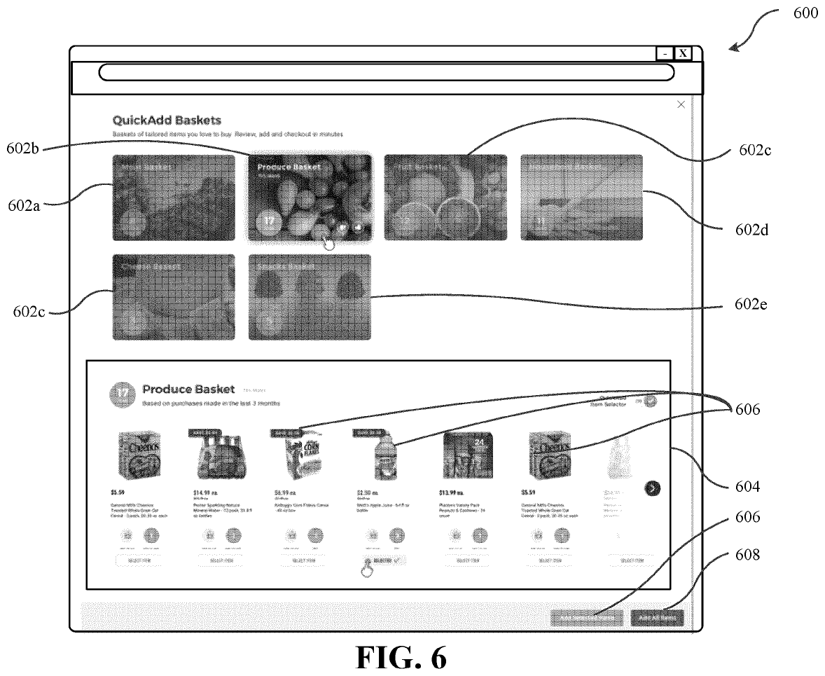

FIG. 6 depicts a window 600 that displays a number of quick-add baskets 602a, 602b, 602c, 602d, 602e (individually and collectively baskets quick baskets 602) shown at the top of the page which also displays a detail display area 604 at the bottom of the same page.

Up on the shopper selecting one of the quick baskets (e.g., basket 602b) the items 606 within the selected basket displayed in the detail display area 604.

A subset of these items 606 may be quickly transferred to the shopping basket by a simple click of a button and the number of items may be quickly increased or decreased using well known user interface elements such as buttons, arrows, dropdowns, dials, sliders, and the like. Many variations will be known to persons of skill in the art. For example, selected of these items 606 may be added to a shopping cart using an “add selected” button 608. Alternately, all of these items 606 may be added to a shopping cart using an “add all” button 610.

In one embodiment, system 100 may allow for a convenient and guided shopping experience that is centered on a particular theme, style or motif. A theme often calls for coordinated decisions regarding items purchased that fit with the intended theme. Similarly, a style usually calls for some coordination of the items purchased to fit within an overall framework associated with that style. Examples of such themes may include meals, activities or wardrobe items fitting a particular event, holiday, white-only party, black-tie affair, etc.

In one specific embodiment, the client side user interface of application 114 may provide the shopper with a convenient and guided method to shop for grocery items geared towards the preparation of a themed meal, themed party, or other type of themed get-together event involving one or more of food items, drinks, activities and decor fitting the theme for the event.

For example, application 114, may be provided with an input indicating the desire of the shopper to purchase items for a thanksgiving dinner for a predetermined number of guests. After receiving data indicative of the theme, and the number of expected guests, application 114 may proceed to provide the data to server 102.

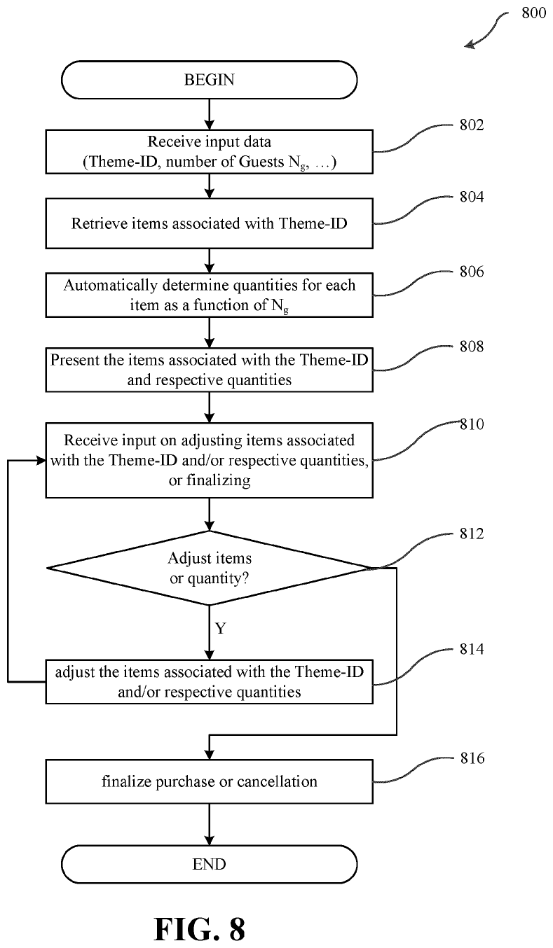

An exemplary process performed by the server 102 will now be described with reference to flowchart 800 of FIG. 8. Having determined some aspects of the themed event such as a theme identifier (i.e., thanksgiving dinner, Christmas lunch, of fall party, Bar Mitzvah, etc.), and that a predetermined number of guests (N_{g}) are expected, an exemplary simple process performed by the server 102.

As depicted, the process starts by receiving data (802) including but not limited to, a theme identifier (Theme-ID) and number of guests Ng.

The process then proceeds to retrieve items associated with Theme-ID (804).

The process then proceeds to automatically determine the quantity Qᵢ for the i^{th} item as Qᵢ=Q(N_{g}) for each item associated with the theme, as a function of the number of guests Ng (806).

As may be appreciated, the quantity depends on the item so that for 10 guests, perhaps 10 disposable dinner plates may be enough whereas 30 napkins or 40 disposable cups may be required as more of the latter items are likely to be consumed by the same number of guests.

The purchase history of previous themed purchases having the same Theme-IQ, by the current purchaser or all or a subset of previous purchasers, along with other factors may be used to compute quantity Qᵢ for the i^{th} item as Qᵢ=Q(N_{g}).

Where N_{g} is used for the first time, an extrapolation algorithm or a rounding to the next higher level of predetermined granularity for N_{g} may be used.

The process then proceeds to Present the items associated with the Theme-ID and determined (by the server 102) respective quantities (808).

The process then receives input on adjusting items associated with the Theme-ID and/or respective quantities, or finalizing (810).

If adjustment is desired (812) then the process running on server 102 adjust the items associated with the Theme-ID and/or respective quantities based on the input received at step 810 earlier. This is iteratively repeated until the user provides an indication (814) of a desire for final purchase or cancellation, which is then carried out (816).

The process then terminates.

A specific exemplary embodiment may involve a holiday meal such as Christmas lunch or Thanksgiving dinner. In such embodiments, the shopper may only need to provide the number of guests. In other embodiments, the shopper may additionally provide a list of allergies to consider.

For instance, the centerpiece of a contemporary Thanksgiving dinner in Canada or the United States very often includes a large roasted turkey, usually served with a variety of side dishes including mashed potatoes, stuffing, and cranberry sauce and depending on the local region other more local additions.

The Theme-ID may indicate that this is a Thanksgiving dinner. The process as identified in flowchart 800 executes to determine the quantities and items needed for say 15 guests (i.e., Ng=15).

The items may include 15 plates, 30 disposable cups, 40 napkins, turkey of sufficient size to feed 15, 3 bottles of wine, 30 bottles of beer, mashed potatoes, stuffing, and cranberry sauce etc.

In certain local areas, such as Alaska, polar bear or whale steak may be included as part of such the dinner. Other regions may introduce their own substitutions or additions depending on the local custom. Such customizations may be done at step 812 and step 814 in FIG. 8. The shopper may manually add, delete or substitute the items or adjust quantities.

Advantageously, automatic predetermination presentation by server 102 at steps 806 and 808 respectively makes the shopping exercise very efficient. Items that may be forgotten are initially already added to the automatic themed packages limiting the chances for repeated purchase transactions or additional trips to the grocery store 120.

A specific exemplary embodiment may involve apparel or wardrobe shopping. In such embodiments, the shopper may only need to provide the selected theme identifier (i.e., Theme-ID or Style-ID). Additionally, parameters indicative of the size of the customer, and whether the customer is a man or a woman, may be provided.

The Theme-ID or Style-ID may indicate that the purchase may be for a black-tie affair.

If the customer is a woman, the server 102 may offer a selection of full-length ball gown and related jewels. A pair of long white gloves may also be offered. Additionally, décolletage or strapless varieties of the gown may be offered.

If the customer is a man, a black dress coat or tailcoat and matching pair of pants or trousers, wing-collared shirt with shirt studs and cufflinks, white piqué waistcoat and white bow tie, black patent leather or calfskin evening pumps and black silk socks may be offered by server 102.

If the customer is a couple, all of the above items may be presented in a matched manner.

Many other apparel styles may be similarly matched and offered by server 102.

In some embodiments of the present invention, a retailer may be able to influence the ranking of items that appear in My Basket or My Store™ based on one or more of: relationships with suppliers; internal inventory levels; campaigns that are underway; profit margins and other factors.

The basic idea behind influencing ranking or boosting is to selectively increase the likelihood of a shopper purchasing the higher ranked items over the lower ranked ones particularly in the absence of other overriding factors. In other words, by prominent placement of higher-ranking items, the system ensures that higher ranked items are more likely to be purchased than their lower ranked substitutes. Server 102 provides basically an override to allow the retailer to boost the ranking of products based on factors such as relationships with suppliers; internal inventory levels; campaigns that are underway; profit margins and other factors as described above. However, that boosting will still take into account the shopper's past behavior.

For example, if a retailer wants to boost the ranking of a new private label healthy snack product, server 102 would still only show that new product to shoppers that have a history of purchasing other healthy snack products. Server 102 will not show the product to shoppers that are uninterested in that category.

The highest ranked items will be displayed in the most prominently visible locations. For example, in a multi-page display of results, the first page may be used to display higher ranked items than the second and subsequent pages. Even within a page, the first few selections or those with attractive graphics or images, increased or colorful fonts that are known to lead to greater statistical chance or probability of being selected may be used to display higher ranked items. Statistical analysis and observations may be used to determine which display areas, colors, fonts, and other attributes will lead to greater likelihood of selection and hence qualified for use with higher ranked items.

For example, if a large bold font is determined to increase likelihood of an item being picked, then premium items or items from preferred suppliers may be listed using said large bold font.

In a variation of the above embodiment, the exemplary system may permit specific business to business communication between the retailer and its suppliers whereby the suppliers can provide information related to redemption rates, costs, revenue increases and the like in relation to selected items.

In exemplary embodiments, this feature is a companion to the boosting or influencing ranking concept described above. In some specific exemplary embodiment, the system server 102 will recommend offers that will boost revenue or improve shopper loyalty.

For example, there may be a number of shoppers visiting the store 120 each week, who almost never spend more than $50. Here, server 102 recommends the retailer offer some subset of such shoppers a coupon for $5 off if they spend over $50. Server 102 would have an expected redemption rate, and other parameters to help the retailer forecast and compare the cost and benefit of the results.

In addition, exemplary embodiments of the server system may compute metrics based on the computed metrics suggest offers to the retailer by providing redemption rates, cost, revenue increase and the like.

A shopper that intends to use exemplary embodiments of the present invention would benefit from a process of onboarding that allows quick and efficient realization of the benefits afforded by the embodiments described herein.

It is desirable to determine a shopper's preferences using the minimum of interactions. This improves the user friendliness of the system and mitigates problems associated with systems that require extensive input or interaction in order to impart the exemplary system with information on preferences. These problems may lead to shoppers simply avoiding the use of the systems if interaction is cumbersome particularly when unrelated to the purpose of the shopper.

In one embodiment, a series of pictorial or pictographic questions may be used to gather data. For example, a shopper may be shown a set of pictures together and he or she may either select one of the pictures or elect to pass. This may be accomplished by the shopper clicking on one of the displayed pictures to select it, or by clicking on a designated button for passing on the item. Of course, other gestures, clicks, touches, swipes, shaking or rotating of the device, buttons that may be physically present in the device or software buttons that may be touched, or clicked, and other control elements such as dropdowns and the like may be used to provide selection input.

The displayed set of pictures may, for example, include one of more of: a handheld basket versus a full grocery cart; a shopper entering a store of a particular band chain (e.g., Weis Markets) versus a composite of shoppers entering multiple grocers; a dog on a pillow versus a cat on a pillow versus just a pillow; and the like. These type of selections may be binary or involve more than two options. A collection of the responses from the shopper will aid in defining a profile or archetype associated with the shopper.

The user interface page for displaying a set of pictures and receiving user input may include a mechanism for navigation such as going back to previous sections and a progress bar indicator which may be interactive and placed either at the top or bottom, or page identifier buttons or section identifier buttons or dropdowns or similar user interface elements.

After the completion of the questionnaire, the system builds an archetype of the shopper. The system (i.e., server 102) then provides an associated typical or archetypal basket for the shopper. For each archetype there may be a predetermined set of items that are placed into the associated archetypal basket. Other items may be automatically added in dependence on further attributes of the specific shopper.

The archetype basket may be added to a representative transaction for this shopper indexed by loyalty card or email. Archetype baskets may serve as hypothetical purchase history either in the absence of actual purchase history. Alternately, the baskets may be used to quickly augment purchase history of a new customer or a new lifestyle adopted by a customer.

If server 102 does not have enough history for a shopper (or as in the case of a new shopper, if there is no purchase history at all) then server 102 may ask a few targeted questions that map or associate the new shopper to one or more representative personas. Server 102 would then create representative transactions that add products popular with those associated personas into the new shopper's history. In effect, a simulated history is created for the new shopper, even though the shopper is new and thus does not have actual transaction history. This permits server 102 to recommend products in the same way as is done for known shoppers with sufficient actual purchase history or transaction history.

At the back end, on the server 102, software or processor executable instructions are provided to create archetypal basket that corresponds to each of the selections in the process of gathering data using the pictorial questionnaire as described above. As a result, archetypal baskets are created for shoppers in each binary category as well as each segment represented by other questions.

Certain characterizations of the sample data from questionnaires can be based on responses of users who already have a log history with the system. Such users may be referred to as “known” users. In one embodiment, on-boarding of known users may be used to characterize or qualify the responses. For example, rates of truthfulness for each question may be determined by computing the ratio of response that match the historical log. Some questions may be readily truthfully answered, while other questions may typically be answered in a far less reliable manner.

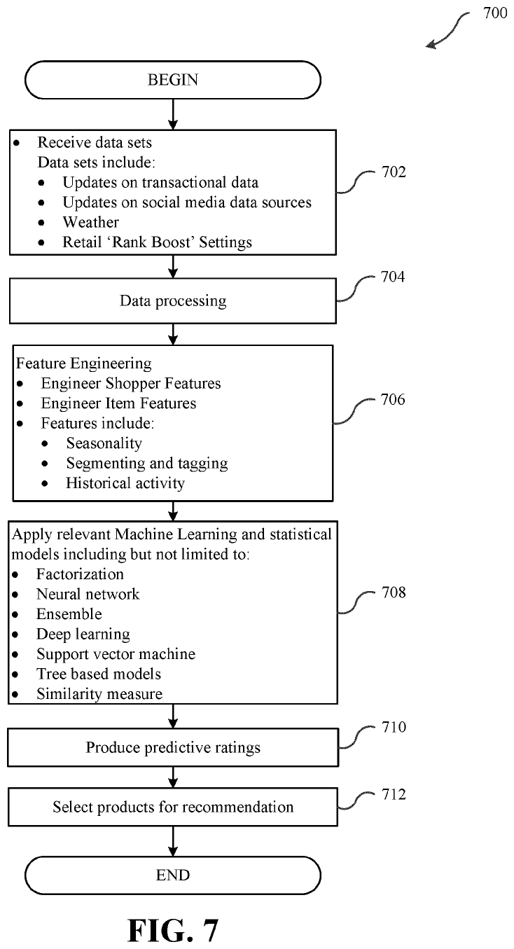

Having determined some aspects of the shopper profile, an exemplary simple process performed by the server 102 is described with the aid of flowchart 700 of FIG. 7. As depicted the process starts by receiving data sets that include but are not limited to Updates on transactional data; updates on social media data sources; weather data; retail ‘Rank Boost’ settings (702).

The process then and proceeds to a data processing step (704).

The process then continues to a feature engineering step (706). Feature engineering step 706 includes: engineering shopper features and engineering item features. Features include but are not limited to seasonality; segmenting and tagging and historical activity.

The process then continues to apply relevant machine learning (ML) and statistical models in the next step (708). Relevant ML and statistical models include but are not limited to: factorization, neural networks, ensemble, deep learning, and support vector machine, tree based models, similarity measure and the like.

The process then and proceeds to produce predictive ratings (710).

The process then and proceeds to select products for recommendation (712) and terminates.

Segmenting or tagging can be a combination of a few factors. First, some segments are binary to which the shopper either belongs or does not. If a shopper buys dog food, the shopper is assumed to have a dog. If the shopper buys diapers, the shopper is assumed to have a baby. Binary segments do not last forever. However, server 102 assumes that a shopper in a given binary segment remains in the segment, until enough history shows otherwise. For example, if a shopper fails to buy diapers when recommend, after a predetermined number of weeks.

The next group of segments is inferred. For example, a shopper frequently buys products that are gluten-free, or never purchases meat products, etc. These are more fluid in nature as even shoppers that buy gluten-free or nut-free products will also purchase products with gluten or nuts.

If a shopper provides input to server 102 that clearly indicates that at attempt to eat healthier in a current year, or to lose weight or to start a specific diet (e.g., Keto) then server 102 associates the shopper to an aspirational segment. With that information, server 102 can recommend products that are outside of the shopper's history but nonetheless remain consistent with the goals of the associated aspirational segment.

Specialized software component, exemplary of an embodiment of the present invention, may be used to segment and tag customers that use the exemplary system. An example of a tag may be vegan. The tags may provide preference clues that immediately rule out certain items (e.g., meat and poultry for vegans) from being offered while increasing the likelihood of presentation of other items of others that may be suitable.

This specialized software component's segmenting and tagging features may be unlocked by making it easy to push data to shopper segments and tags back to retailers or to third party systems such as a content management system (CMS), Email Service Provider (ESP) loyalty systems, proprietary retailer databases, and the like.

All of the tagging above is useful in other scenarios in addition to e-commerce product recommendations. Sharing this tagging information outside of server 102 will enable retailers to hyper-target content to specific subsets of their shopper population.

As noted just above, in exemplary embodiments of the present invention, shoppers may be tagged with one or more tags or labels that identify shopping preferences or likelihood of interest or disinterest in certain items.

In exemplary embodiments of the present invention, shoppers' preferences, tags and other data may be pushed to retailers and other third party systems to improve matching of supplied items against certain criteria such as shopper preference. Such information sharing may allow third parties to further optimize offerings at the source.

In addition, exemplary embodiments include a software module of processor executable instructions that when executed implement an algorithm for determining seasonal products and their respective season based on one or more of transaction logs from previous purchase history, browsing history, calendar, demographic data that may include age, religion, location, and other profile entries.

In addition, exemplary embodiments include a software module of processor executable instructions that when executed implement an algorithm for determining all staple products using on one or more of transaction logs from previous purchase history, browsing history, calendar, demographic data that may include age, religion, location, and other profile entries.

In addition, exemplary embodiments include a software module of processor executable instructions that when executed implement an algorithm for determining all products excluding seasonal and staple products using one or more of transaction logs from previous purchase history, browsing history, calendar, demographic data that may include age, religion, location, and other profile entries. This may be easily accomplished by subtracting seasonal and staple items computed above from all items purchased or likely to be purchased by a customer.

In addition, exemplary embodiments include a software module of processor executable instructions that when executed implement an algorithm for determining determine average replenishment rate of staple products globally using one or more of transaction logs from previous purchase history, browsing history, calendar, demographic data that may include age, religion, location, and other profile entries. This may be easily accomplished by subtracting seasonal and staple items computed above from all items purchased or likely to be purchased by a customer.

In addition, exemplary embodiments include a software module of processor executable instructions that when executed implement an algorithm for determining determine average replenishment rate of staple products across various segments using one or more of transaction logs from previous purchase history, browsing history, calendar, demographic data that may include age, religion, location, and other profile entries. This may be easily accomplished by subtracting seasonal and staple items computed above from all items purchased or likely to be purchased by a customer.

In addition, exemplary embodiments include a software module of processor executable instructions that when executed implement one or more algorithms for determining brand sensitivity or brand affinity of a consumer. This may be based on one or more of transaction logs from previous purchase history, browsing history, calendar, demographic data that may include age, religion, location, and other profile entries. This may be easily accomplished by subtracting seasonal and staple items computed above from all items purchased or likely to be purchased by a customer.

In addition, exemplary embodiments include a software module of processor executable instructions that when executed implement one or more algorithms for price sensitivity of a consumer. This may be based on one or more of transaction logs from previous purchase history, browsing history, calendar, demographic data that may include age, religion, location, and other profile entries. This may be easily accomplished by subtracting seasonal and staple items computed above from all items purchased or likely to be purchased by a customer.

Although detailed exemplary embodiments have been discussed in relation to grocery stores, those of skill in the art will readily understand that the invention is not confined to just grocery stores but may be used in any formal or informal physical retail and other spaces where goods, services and other intangibles, are exchanged, sold, bartered or traded.

It is contemplated that any part of any aspect or embodiment discussed in this specification may be implemented or combined with any part of any other aspect or embodiment discussed in this specification. While particular embodiments have been described in the foregoing, it is to be understood that other embodiments are possible and are intended to be included herein. It will be clear to any person skilled in the art that modification of and adjustment to the foregoing embodiments, not shown, is possible.

Unless defined otherwise, all technical and scientific terms used herein have the same meaning as is commonly understood by one of ordinary skill in the art to which this invention belongs. In addition, any citation of references herein is not to be construed nor considered as an admission that such references are prior art to the present invention.

The scope of the claims should not be limited by the example embodiments set forth herein, but should be given the broadest interpretation consistent with the description as a whole.

What is claimed is:

1. A server system, comprising: a processor; a memory; a communication interface; and a non-transitory processor readable medium storing processor executable instructions configured to be executed by the processor, the processor executable instructions for:
maintaining a plurality of items to be purchased;
maintaining a plurality of item identifiers corresponding to said plurality of items;
receiving input from a shopper, the input comprising an item identifier associated with at least one of the plurality of items to be purchased by the shopper;
maintaining purchase history for the shopper based on the input; and
offering to the shopper, new items to be purchased, based on said purchase history.

2. The server system of claim 1, wherein the input further comprises creating a plurality archetype digital baskets based on said purchase history, each archetype basket corresponding to a subset of the items.

3. The server system of claim 1, wherein the new items are offered based on brand affinity.

4. The server system of claim 1, wherein the new items are offered based on price sensitivity.

5. The server system of claim 1, wherein the new items are offered based on archetype determined for the shopper.

6. The server system of claim 1, wherein the new items are offered based on supplier relationships

7. The server system of claim 1, wherein the new items are offered based on profit margin associated with the new items.

8. The server system of claim 1, wherein said processor executable instructions further comprise instructions for:
determining that the purchase history is insufficient,
prompting for at least targeted question and
based on that map or associate the new shopper to one or more representative personas.

9. A method of electronic commerce comprising:
maintaining a plurality of items to be purchased;
maintaining a plurality of item identifiers corresponding to said plurality of items;
receiving input from a shopper, the input comprising an item identifier associated with at least one of the plurality of items to be purchased by the shopper;
maintaining purchase history for the shopper based on the input; and
offering to the shopper, new items to be purchased, based on said purchase history.

10. The method of claim 8, wherein the input further comprises creating a plurality archetype digital baskets based on said purchase history, each archetype basket corresponding to a subset of the items.

11. The method of claim 8, wherein the new items are offered based on brand affinity.

12. The method of claim 8, wherein the new items are offered based on price sensitivity.

13. The method of claim 8, wherein the new items are offered based on archetype determined for the shopper.

14. The method of claim 8, wherein the new items are offered based on supplier relationships

15. The method of claim 8, wherein the new items are offered based on profit margin associated with the new items.

16. A server system, comprising: a processor; a memory; a communication interface; and a non-transitory processor readable medium storing processor executable instructions configured to be executed by the processor, the processor executable instructions for:
receiving data comprising a theme identifier (Theme-ID) and a number of guests Ng from a current purchaser;
retrieving items associated with the Theme-ID from a data store;
automatically determining the quantity Qi for the ith item of a plurality of items, as Qi=Q(Ng) for each item associated with the theme as a function of the number of guests Ng using a purchase history of previous themed purchases having the same Theme-IQ, by a current purchaser or all or a subset of previous purchasers,
wherein Ng if is used for the first time, an extrapolation algorithm is used to the next higher level of predetermined granularity for Ng.

17. The server system of claim 16, wherein the input further comprises instructions for adjusting the quantity Qi.
